(19) United States
(12) Patent Application Publication
(10) Pub. No.: US 2006/0032197 A1
(43) Pub. Date: Feb. 16, 2006

(54) Bag house filters and bag section repair and replacement kit

(76) Inventor: Donald R. Pyron, Smackover, AR (US)

Correspondence Address: Stephen D. Carver, Suite 800, 2024 Arkansas Valley Drive, Little Rock, AR, 72212-4147, US

(21) Appl. No.: 11/199,694

(22) Filed: Aug. 9, 2005

Related U.S. Application Data
(60) Provisional application No. 60/600,603, filed on Aug. 12, 2004.

(51) Int. Cl. B01D 46/02

(52) U.S. Cl. 55/372

(57) ABSTRACT

An improved multiple segment baghouse filter, and a kit and method for replacing or repairing existing, damaged baghouse filters. Instead of removing and replacing the entire length of a damaged filter, a separate repair portion is spliced into the filter. A damaged bag section is removed, and the undamaged remainder is trimmed and folded. The kit has a spool-like splicing drum that forms a junction between the undamaged and damaged repair sections. The molded plastic splicing drum comprises a central, reduced diameter annular region from which a pair of diverging edge segments integrally extend. The outwardly flared wedge portions terminate in lips that aid in securing filter segment ends which are drawn over the lips and retained upon the wedge segments. The new filter design employs the splicing drums as original equipment, reducing the complexity and difficulty of subsequent filter repairs.

### CROSS REFERENCE TO RELATED APPLICATION

This application is based upon, and claims priority from a U.S. Provisional Patent Application entitled “Bag Section Replacement System For Bag House Filters,” Ser. No. 60/600,603, Filed Aug. 12, 2004.

### BACKGROUND OF THE INVENTION

I. Field of the Invention

The present invention relates generally to bag house filter systems. More particularly, the present invention relates to the construction, repair and replacement of tubular, fabric, bag house filters.

II. Description of the Prior Art

Commercial baghouses of various configurations, including pulse jet, reverse air, and shaker baghouse designs, are in widespread industrial use for removing gas-borne particulates generated in various manufacturing or industrial processes. Reverse air bag house filter installations, operating either under positive or negative pressure configurations, are common with steel mills, cement and limestone plants, and other installations where dust collection for air pollution control is mandated. Reverse air type baghouses include numerous separately suspended, capped filters establishing a fluid flow passageway between an inlet volume that receives dirty gas to be filtered, and a vented outlet volume for exhausting cleaner, filtered air or gas. Multiple, tube-like, fabric filter bags hung from J-hooks in an upper plenum provide a fluid flow path trap to the vent system. The lower ends of the bag filters are coupled to various collars in a tube sheet floor, and gas enters the tubes through the collars. Particulates borne by the entering gas stream are trapped and captivated by the filter body.

Numerous prior art baghouse and baghouse filter designs are known in the art. Most designs include some form of header plate or cell plates, often referred to as tube sheets, that divide and separate adjacent baghouse volumes. The purpose of the tube sheet is to direct the gas flow to the inside of the filter bag, thus forcing gas to pass through fabric of the filter bag before it can exit through the clean air plenum. Suitable collars or attachment fixtures coaxially associated with orifices defined in the headers facilitate attachment of elongated, tubular filter bags. For example, an open end of each filter bag may be attached to the tube sheet collar with conventional, encircling clamps or bands. Other attachment techniques include clampless thimbles, double-beaded snap bands, and single snap bands.

Reverse air filter bags are usually reinforced by a series concentric, spaced apart reinforcing rings that prevent the bags from totally collapsing in response to pressure differentials during cleaning cycles. Filter bags are available in several different lengths and diameters. They can measure upwardly from four inches in diameter, and lengths as long as forty feet are common. Typically, the tubular filter bags are oriented vertically within the air plenum, and their large size and appreciable mass aggravate stresses during operation.

A typical baghouse is seen in U.S. Pat. No. 5,017,200 issued to Price May 21, 1991. The baghouse comprises a chamber divided into an inlet for receiving a gas stream containing particulates, an outlet for exhausting the gas stream after filtering, a main chamber and an auxiliary chamber. Numerous filter bags are housed within the main chamber.

Many filter bags have tube-like, fabric exteriors that surround an inner, rigid skeleton comprised of wire or metal. The bags may be conventionally attached to orifices in a tube sheet. Units designed in this manner collect particulates on the inside of the bag and generally require periodic shaking to dislodge the particulates. Usually the filter bags include resilient connection members that allow them to be fitted to the header or plate fixtures. For example, U.S. Pat. No. 4,303,425 issued to Cox Dec. 1, 1981 shows a filter bag assembly for releasable attachment to a circular cap. The coupling includes a flexible, wire ring and a concentric, expandable ring enclosed in an external cuff turned on the end of the filter bag.

A secure and reliable connection prevents particulate waste from escaping the baghouse chamber. Some designs use a rigid self supporting fabric. Filters having fabric formed over rigid frames are commercially known as “cartridges.” These designs can collect particulates on either side of the fabric. Typical filter cartridges have an inner, perforated tubular sleeve coaxially surrounded by an annular filter, often comprising resin impregnated paper. The filter media may be pleated to maximize the working surface area of the filter media.

During the initial phase of a filter's life, particles are captured on and within the fabric comprising the filter body. Eventually, dust and debris accumulates on the fabric, forming a layer of particulates that affects gas or air flow. There are various known methods for cleaning filter bags, including the periodic pulsing of pressurized air. Particles dislodged during cleaning may drop to a collection area below the tube sheet, within the gas entry region, for example, that may comprise a lower trap door or valve that may be opened during bag cleaning processes. In some configurations periodic cleaning can be accomplished with reverse air flow pressure jets. Regular cleaning extends the useable life of the filter, but ultimately the filter bags deteriorate and weaken structurally in response to heat, pressure, time, and chemical action. Where the rigid cage structure of the bag weakens, collapse of the filter bag can occur.

Another problem is that the bag fabric ultimately ruptures. Most filter bag failures occur near the bottom of the filter. Once ruptured regions are discovered, filter bags can be repaired, but often the entire length of the bag must be replaced. Hitherto, it has been difficult to splice bags in the regions that are torn or ripped. Reinforcement rings used with reverse air systems are linked to the bag by sewing; in other words, several fabric stitches around the region of the reinforcement rings stabilize and anchor the rings in place, making it difficult, if not impossible, to make practicable field repairs.

Periodic filter bag maintenance activities are labor intensive and time-consuming. To simplify maintenance, filter bags should be releasably coupled to the tube sheet collar structure, and to intermediate coupling regions. An airtight seal must be maintained to prevent the escape of particulate matter around coupling joints. Because of the high volume of gas flow, the high temperatures involved, abrasion, and the presence of sparks, filter bags inevitably degrade over time. Normally the collar coupling comprises a circular flange or rim that is surmounted by the end of the filter bag. A circular steel band attaches the bag like a hose clamp. As use continues, ordinary wear and tear degrades bag integrity. Rips and tears often occur, particularly at regions proximate the joints. Since, as described above, secure and reliable air tight joints must be established, the hardware is expensive, and as a result the bags include a minimum of such couplings. Thus when a break or tear occurs in one segment of an elongated bag filter, the entire length of the bag must be replaced.

U.S. Pat. No. 4,424,070 issued to Robinson Jan. 3, 1984 shows means for attaching a filter cartridge to the underside of a baghouse tube sheet with flanges. An internal flange of an upper bag is riveted to the underside of the tube sheet, while the internal flange of the lower bag portion is bonded to an upper collar of the filter cartridge.

Other prior art designs known to me showing baghouses and filter bags or cartridges are seen in the following art:

a) U.S. Pat. No. 4,595,402 issued to Silletto Jun. 17, 1986;

b) U.S. Pat. No. 5,061,303 issued to Williams Oct. 29, 1991;

c) U.S. Pat. No. 5,308,369 issued to Morton May 3, 1994;

d) U.S. Pat. No. 6,001,145 issued to Hammes Dec. 14, 1999;

e) U.S. Pat. No. 6,375,698 issued to Clements Apr. 23, 2002; and,

f) U.S. Pat. No. 6,626,970 issued to Pipkorn Sep. 30, 2003.

Most bag failures take place at the junction where the filter bag is connected to the tube sheet. Once a filter bag has a hole in it, up until now, the entire bag had to be replaced. For example, where a thirty foot filter bag twelve inches in diameter develops a leak in its bottom, current the practice is to replace the entire unit. With the concept of this invention, bags are simply detached at the retainer on the tube sheet or cell plate junction, and then cut just below an anti-collapse ring.

### SUMMARY OF THE INVENTION

This invention provides an improved baghouse filter, and repair systems baghouse filters. Where a tear or break has occurred in a particular segment or portion of an elongated bag filter, instead of removing and replacing the entire length of the unit, a separate repair portion may be spliced in to effectuate repairs.

A customized splicing repair section is first cut and sized appropriately. A broken baghouse filter length is cut and trimmed beneath its nearest reinforcement ring or connection juncture. The ends are folded over inside and prepared for coupling to a unique, spool-like splicing drum.

The resilient splicing drum or spool is used for repair kits and for original equipment installation. The spool functions both as an anti-collapse reinforcement ring, and as a mechanical junction for section replacements. The annular splicing spool has a central tube-like perimeter, defined between upper and lower flared wedge segments or walls that diverge slightly toward the perimeter away from center. The flared body resembles a pair of aligned conical segments, each end flaring outwardly from the middle of the tubular body. The outside upper and lower perimeter form lips over which bag section ends are preferably stretched for installation. The inner perimeters of the splicing spool are dimensioned to frictionally interfit with reinforcement rings or snap-bands for direct coupling splices. By way of example, if a particular bag has a torn section, the specialized spool section allows the removal of the defective bag section, followed by repair and splicing of the filter bag. This will help the manufacturer with warranty issues and save the end user countless dollars.

It is thus an important object of this invention to provide a method and apparatus for repairing and splicing baghouse filters.

Another basic object of my invention is to simplify the repair of bag house filter elements, particularly in conjunction with reverse air baghouse configurations.

It is also an important object to provide an improved baghouse filter that is designed to ease and simplify future maintenance and repairs.

A related object is to provide a filter bag design which is quickly and easily installed to either the tube sheet collar, or to adjacent bag sections or segments.

Anther important object is to provide an effective, airtight seal when splicing bag filters.

It is a related object of this invention to provide an improved splicing system that is suitable for repairing and coupling neighboring segments of repaired bags.

Still another object of this invention to provide a baghouse repair and splicing system, which minimizes labor, and time constraints, while insuring the effective repair and replacement of the critical baghouse filters.

It is another object of my invention to easily repair bag filter leaks caused by fabric rupture or burn holes caused by sparks.

Another important object is to ease the repair of baghouse filters by providing a simplified means for axially coupling segments together.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a fragmentary isometric view showing the interior of a conventional baghouse filter and a typical baghouse filter section requiring repair or replacement;

FIG. 2 is a fragmentary isometric view showing a baghouse filter section that is to be repaired, which has been cut at the required location;

FIG. 3 is an enlarged, fragmentary isometric view of region 3 that is circled in FIG. 2, showing the connection ring region prior to repair;

FIG. 4 is an enlarged, fragmentary isometric view showing how the lower fabric segment is preferably folded back prior to repairs in accordance with the invention;

FIG. 5 is a fragmentary isometric diagrammatic view showing how a lower repair segment is directed towards an upper segment and the preferred splicing drum;

FIG. 6 is an enlarged, fragmentary elevational view showing how a lower repair segment is directed towards the preferred splicing spool, with portions thereof broken away or shown in section for clarity;

FIG. 7 is a fragmentary elevational view showing how the lower repair segment is angularly pre-fitted to the preferred splicing drum, with portions thereof broken away or shown in section for clarity;

FIG. 8 is an enlarged, fragmentary isometric view derived from FIG. 7 that further illustrates how the repair segment is angularly pre-fitted to the preferred splicing spool;

FIG. 9 is a fragmentary elevational view showing a lower repair segment properly fitted to the preferred splicing drum, with portions thereof broken away or shown in section for clarity;

FIG. 10 is a fragmentary isometric view of the repaired tube filter of FIG. 9, showing how the band clamp is thereafter attached, with portions thereof shown in section or omitted for clarity;

FIG. 11 is an enlarged, fragmentary isometric view derived from circled region 11 in FIG. 10;

FIG. 12 is an isometric view of the preferred hose clamp;

FIG. 13 is an enlarged isometric view of the preferred splicing drum, with portions thereof shown in section or omitted for clarity;

FIG. 14 is an enlarged, fragmentary elevational view of a portion of the splicing drum derived from circled region 14 in FIG. 13;

FIG. 15 is a fragmentary isometric view of a repaired filter bag, with portions thereof shown in section or omitted for clarity;

FIG. 16 is an isometric view of a repaired filter bag, with portions thereof shown in section or omitted for clarity;

FIG. 17 is an exploded isometric view of a filter bag constructed in accordance with the best mode of the invention;

FIG. 18 is an enlarged, fragmentary isometric view of the new filter bag, showing how the tapered locking bands engage the splicing drum, with portions thereof shown in section or omitted for clarity;

FIG. 19 is an enlarged, fragmentary isometric view derived from circled region 19 in FIG. 18, with portions thereof shown in section or omitted for clarity;

FIG. 20 is a fragmentary isometric view of a new filter bag; and,

FIG. 21 is an isometric view of a new filter bag.

### DETAILED DESCRIPTION

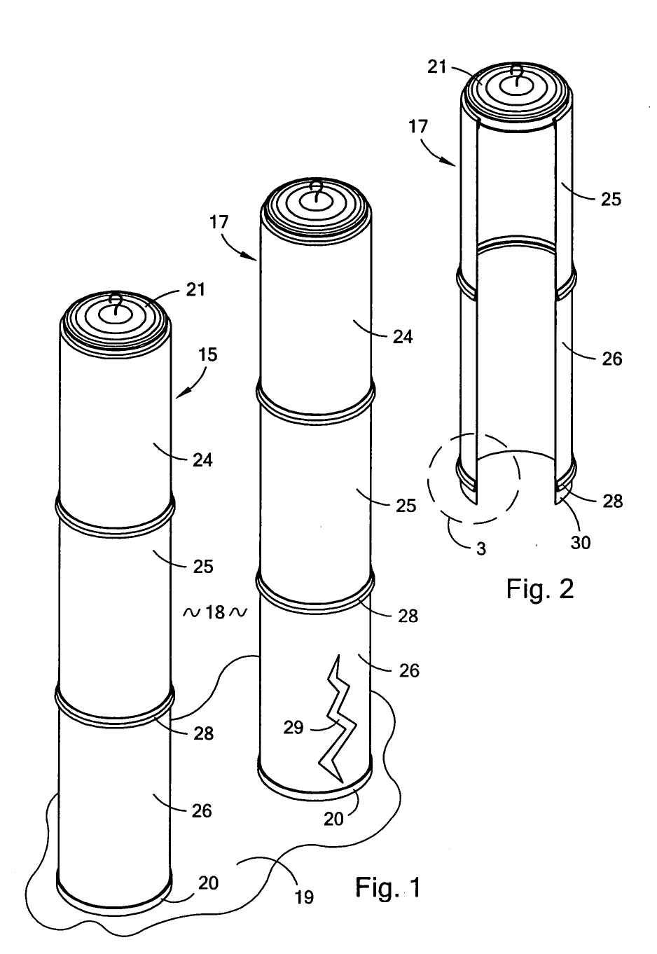

With initial reference directed now to FIG. 1 of the appended drawings, a plurality of tubular bag filters 15, 17 are disposed vertically within an air plenum, designated generally by the reference numeral 18. Plenum 18 is defined above a tube sheet 19 that forms the floor. The bag filters 15, 17 are coaxially coupled at their bottom to circular mounting collars 20 that coaxially surround suitable conventional orifices defined in the tube sheet 19. A conventional top 21 enables the filters 15, 17 to be hung by suitable hooks, or conventional chains with drawbars. Particulate-carrying gas travels through the bag filters through the tube sheet orifices, entering the bag interior and depositing particulate waste therewithin. Gases (i.e., filtered air) escaping through the bag fabric into the plenum 18 exits the baghouse though suitable conventional outlet vents (not shown) that are well known to those with skill in the art.

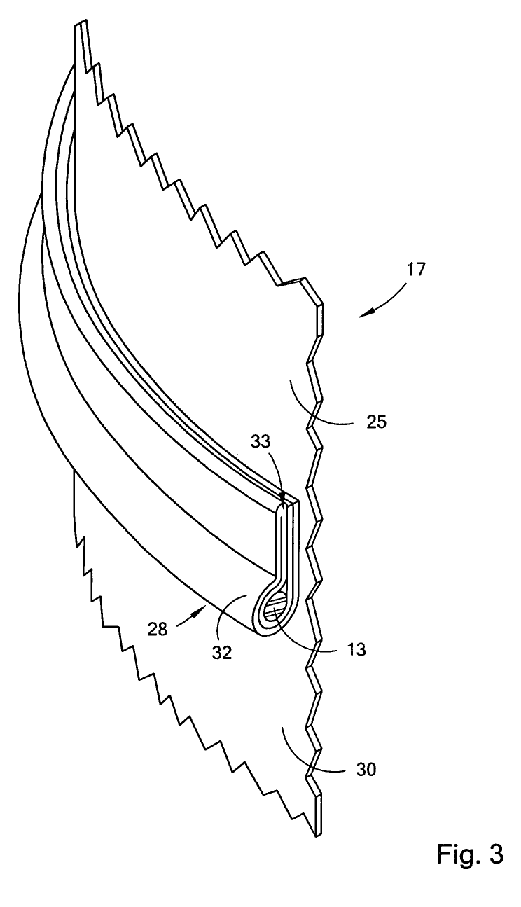

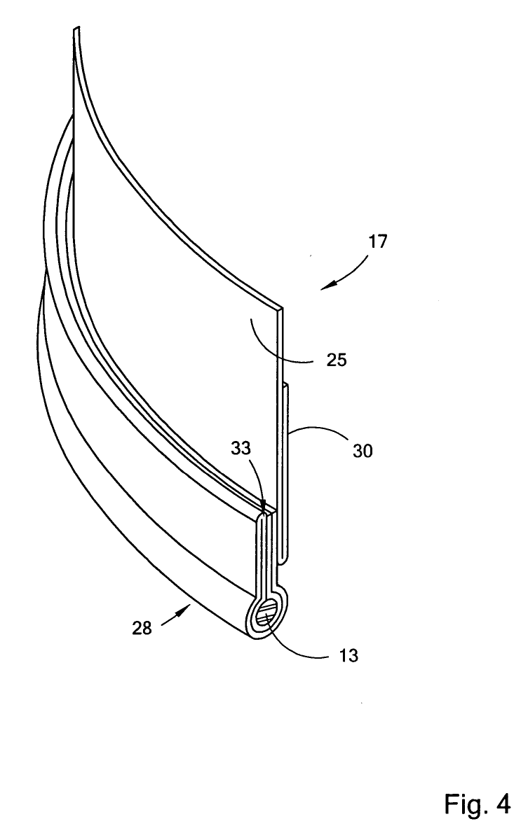

The conventional bag filters 15, 17 comprise multiple, axially aligned and joined sections 24, 25, 26 that are sewn together and joined at a fabric junction regions 28. The fabric junction region 28, and the bag filter generally, are reinforced by conventional rigid, circular reinforcement rings concentric with junction regions 28. These rings 13 (FIG. 3), known as “anti-collapse” rings, are sewn within the tubular bag body. The lower bag segment 26, whose bottom is attached to the collar 20 beneath it, is seriously damaged and torn. The torn and damaged region 29 necessitates repair or replacement of the bag filter, and in the prior art, the known procedure is to remove the entire length of the old bag and install a new one. The invention proposes solutions for the economical repair of such damage. The invention further proposes an new OEM filter system that eases such repairs when they inevitably become necessary.

With additional reference directed to FIGS. 2-4, the bag house filter 17 is to be repaired according to the invention. Filter 17 has been trimmed immediately below lower junction region 28. The damaged segment 26 (FIG. 1) has been cut away and removed, leaving a small, ragged lower portion 30 below the anti-collapse ring and above collar 20. FIG. 3 illustrates how the anti-collapse ring 13 is sewn into the junction region 28. Segment 25 is sewn together with a double lapped loop 32 of filter material that encompasses ring 13, and which terminates in a pair of folded and doubled-over flaps 33 sewn to segment 25. As seen in FIG. 4, the lower portion 30 remaining after trimming has been folded upwardly and attached to the inside of filter segment 25, so that it no longer touches region 28.

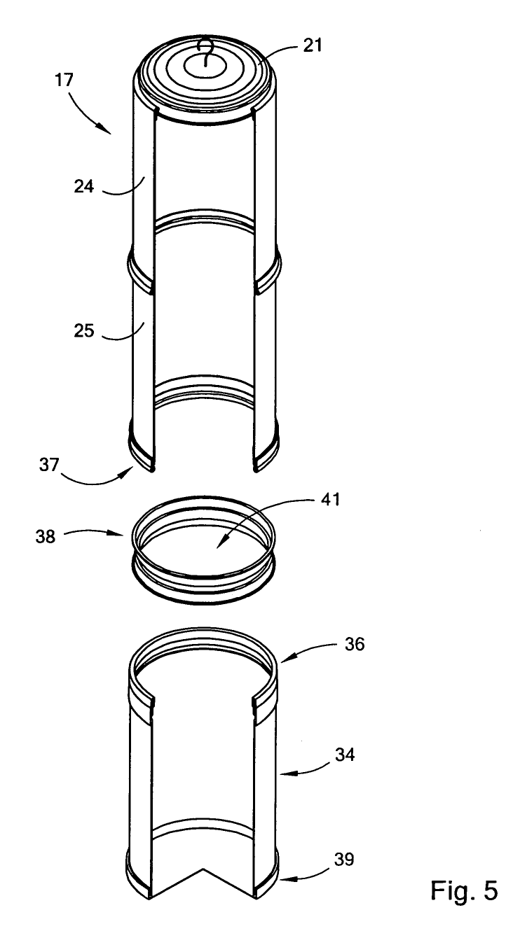

Referencing FIGS. 5 and 8, an elongated, tubular replacement section 34 is to be spliced in and attached for repairs. The top region 36 of section 34 is attached to an annular, spool-like splicing drum 38 in accordance with the invention as hereinafter described. Preferably there are one or more radially spaced-apart belt loops 35 sewn into the top of the repair section 34 to aid in manipulation of it. The bottom 37 of upper segment 25 is also attached to splicing drum 38 as hereinafter described. The lowermost portion 39 of repair section 34 extends downwardly and is eventually attached to the lower collar in the tube floor to complete repairs.

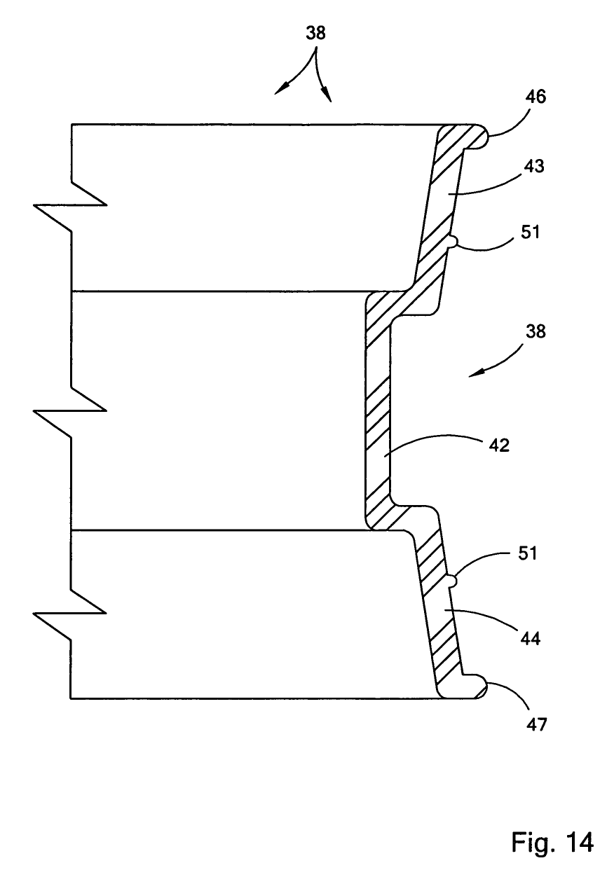

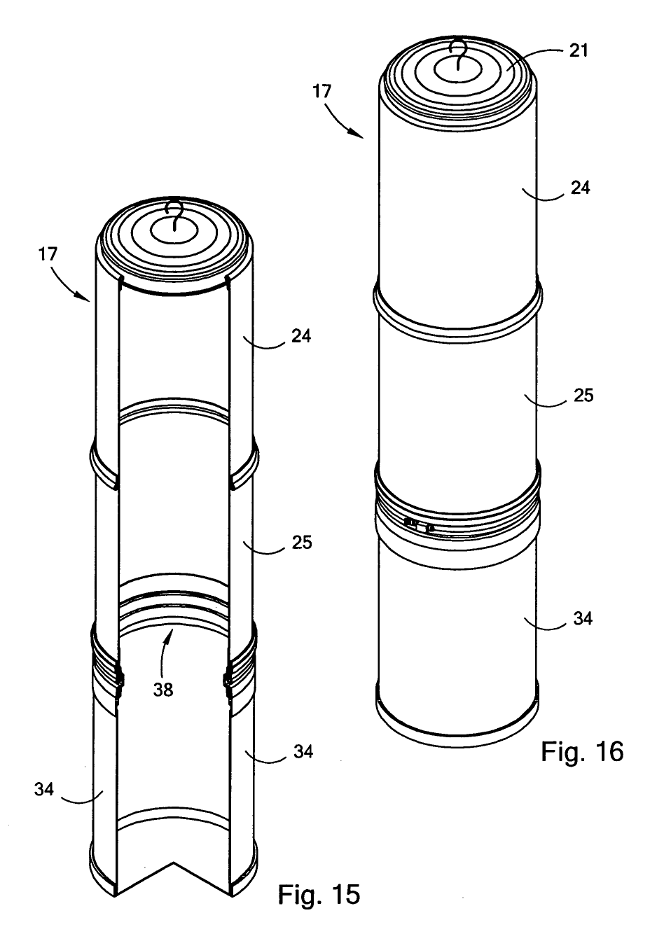

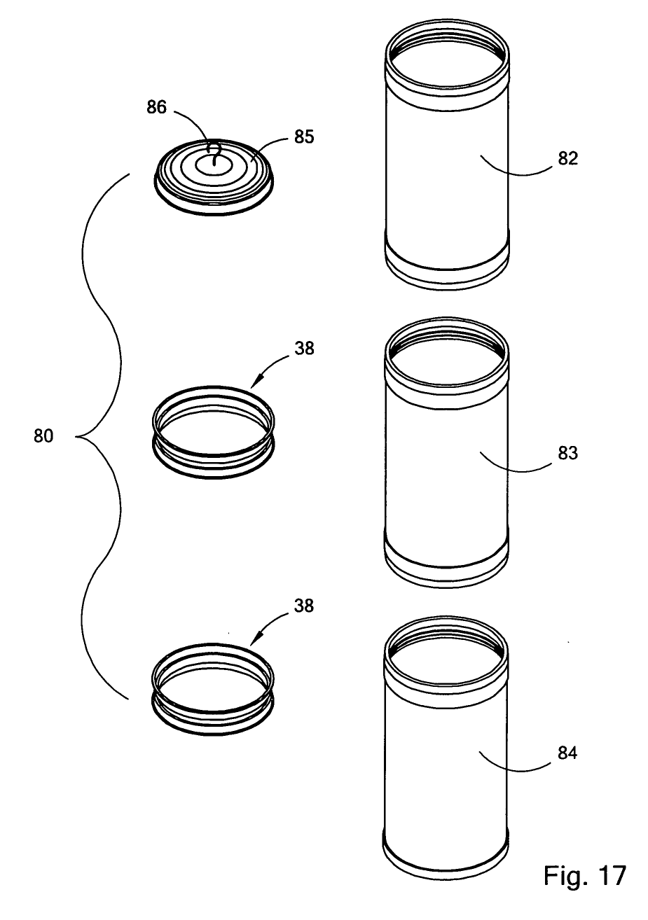

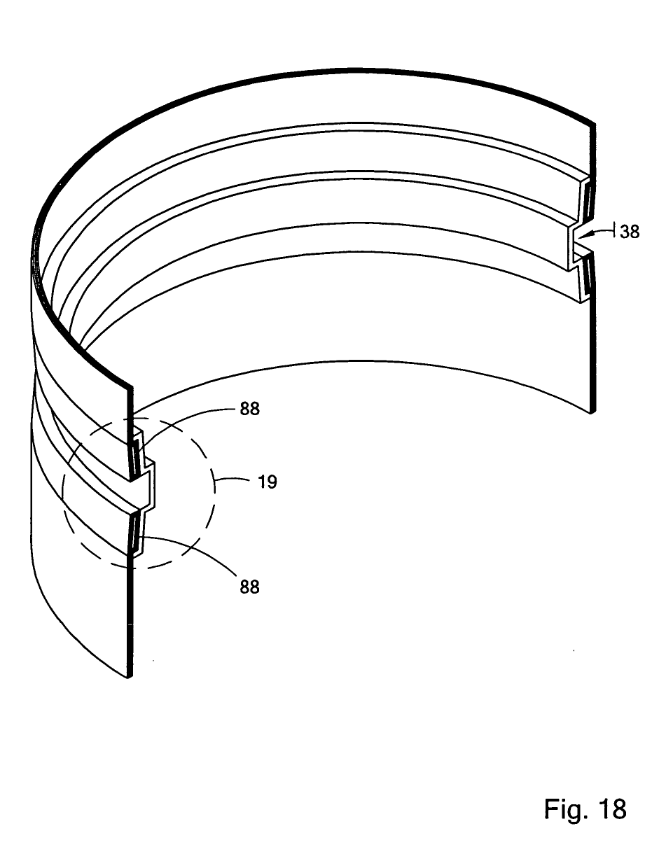

Referencing particularly FIGS. 5-14, the preferred approach for patching and repairing damaged bag house filters requires the use of the specially designed splicing drum 38. The resilient, preferably molded drum enables repairs at any particular point or junction region, with or without the presence of a reinforcement ring, anti-collapse ring, or conventional snap band. Drum 38 is in the general form of an annular band or spool, coaxially surrounding a circular region 41 (FIG. 5). Drum 38 comprises a central, lowest diameter ring region 42 coaxially adjoining integral, and diverging wedge portions 43, 44. Rings region 42 forms the drum midpoint. The coaxial wedge portions 43, 44 diverge away from opposite ends of the central ring region 42, and terminate in outer, coaxial, raised-diameter lips 46, 47 (FIG. 7) respectively. The circular interior side of ring region 42 has been designated by the reference numeral 42A (FIGS. 8, 13). The circular interior sides of diverging wedge portions 43, 44 have been respectively designated 43A and 44A (FIG. 8). In the best mode, wedge regions 43, 44 preferably have coaxial, raised ridges 51 encircling the drum 38, that aid in seating the bag sections.

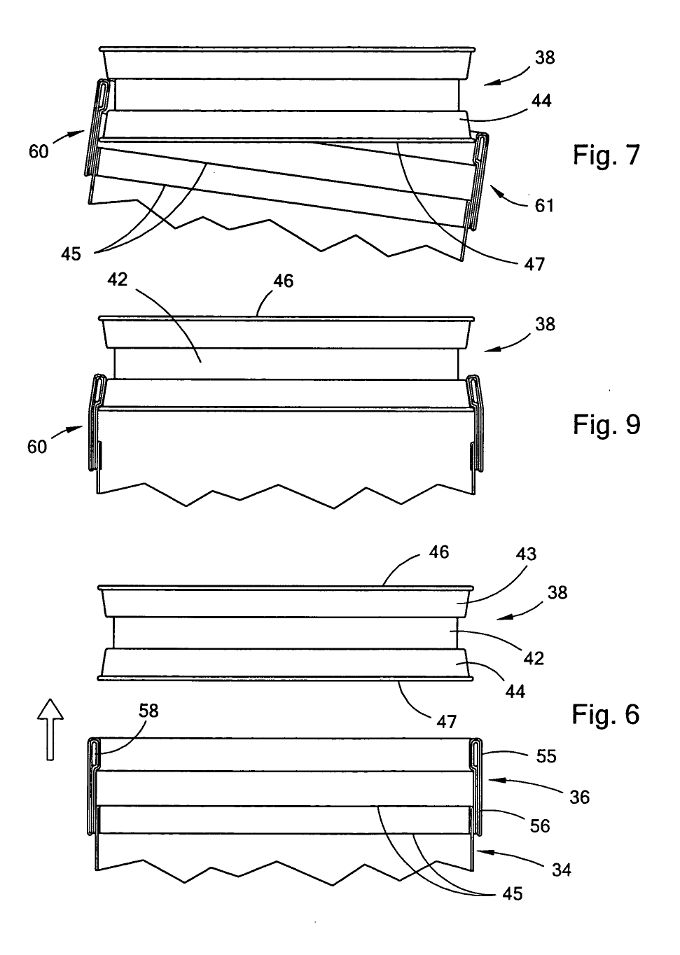

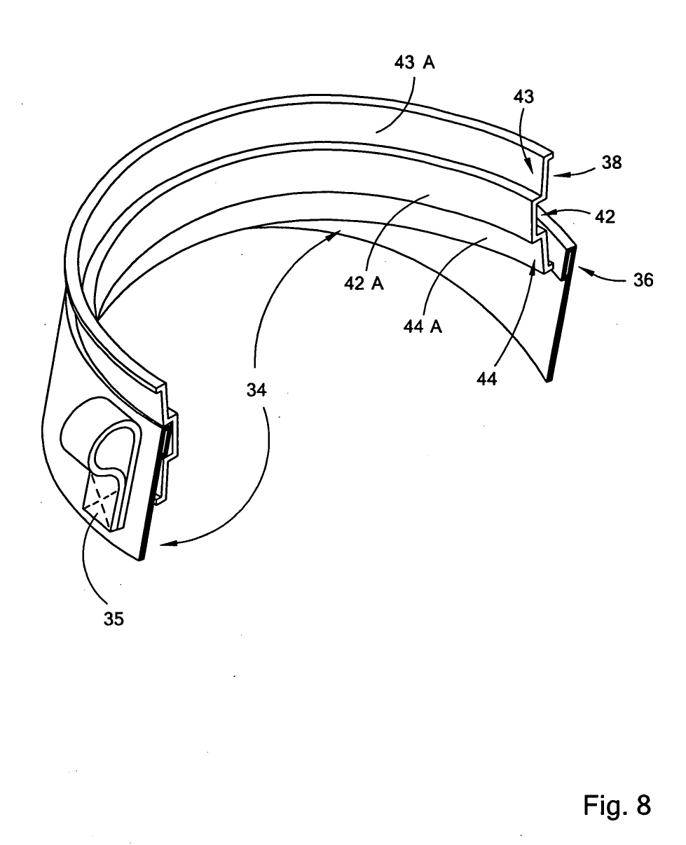

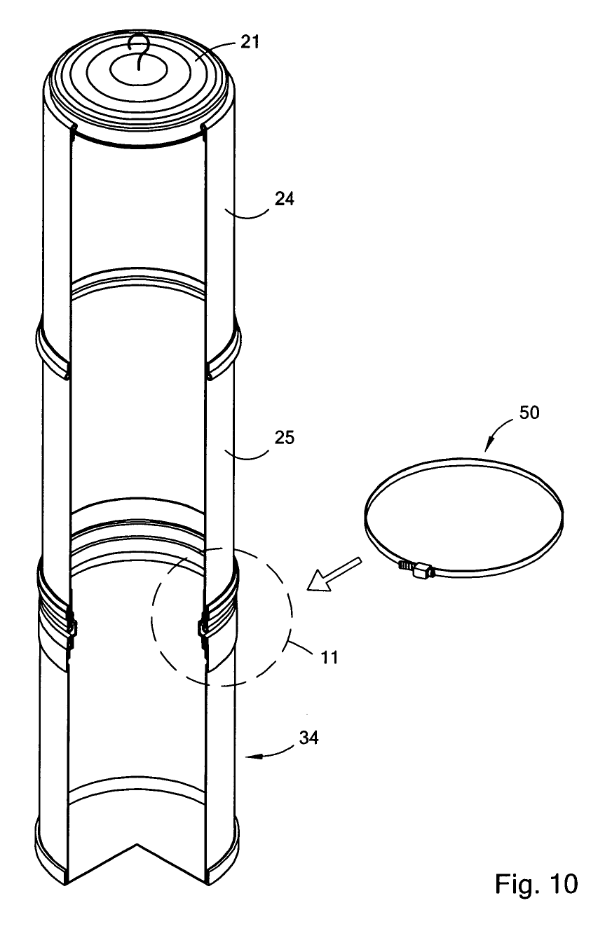

The reinforced fabric end 36 of the repair section 34 is to be fitted over the spool lower wedge portion 44 for splicing. The reinforcement stitches 45 (FIGS. 6, 9) make manipulation difficult, so the procedure in FIGS. 6, 7 and 9 is recommended. In general, ends of bag sections to be repaired or spliced can be forced over wedge portions 43, 44 and the lips 46, 47, and once released, they will be captivated upon the splicing drum 38. For additional strength a circular band clamp 50 (FIGS. 10, 12) may be employed. It will be appreciated that a suitably dimensioned snap band, such as that which may remain in older filter segment 25 (FIG. 5) and its bottom end 37, may be coaxially snap fitted over the top of drum 38 surmounting wedge 43. A connection may thus be made with a portion of a baghouse filter via an original snap band, which are omitted in the proposed repair section 34 (FIG. 5).

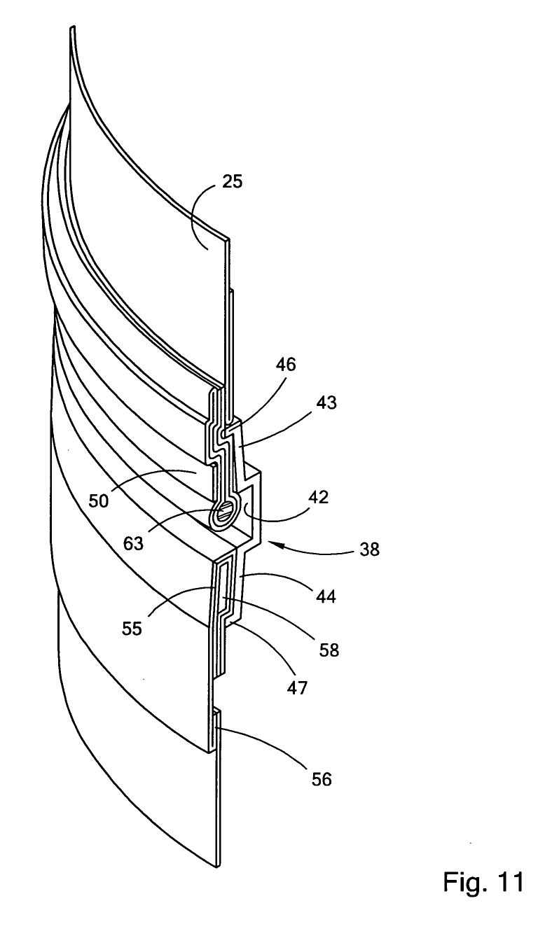

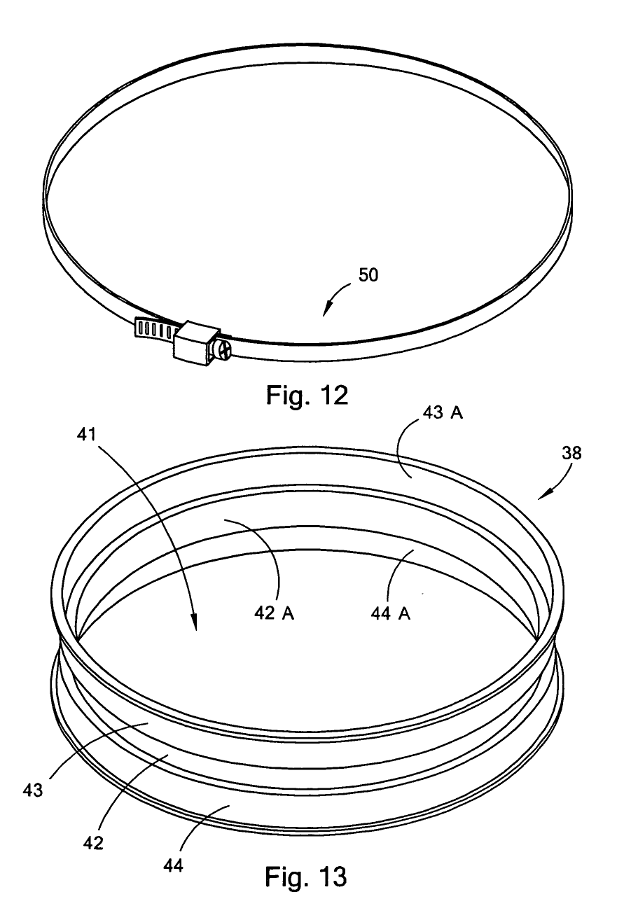

Referencing FIG. 6, repair section 34 is to be spliced into the filter 17 by attachment to drum 38. The end 36 comprises folded fabric conformed to make a pair of concentric, spaced apart compression ring portions 55, 56. Optionally a separate resilient, metallic or plastic snap band may concentrically occupy circular ring region 58 (FIGS. 6, 11). As seen in FIG. 7, the circular open end 36 is rocked and tilted to surmount splicing drum 38. The left end 60 (i.e., as viewed in FIG. 7) is first drawn over lip 47 of the splicing drum 38 to rest within and over wedge portion 44. As seen in FIGS. 8 and 9, the opposite side 61 is then gently forced over the lip 47, forming the configuration of FIG. 9. The lower portion of original undamaged segment 25 is then fitted to the top of splicing drum 38, where it is retained by its internal snap band 63, that concentrically occupies central ring region 42 that provides an annular ring for seating. The conventional hose clamp 50 (FIGS. 10-12), may secure the segment 25 against the spool wedge section 43, to complete and reinforce the splice.

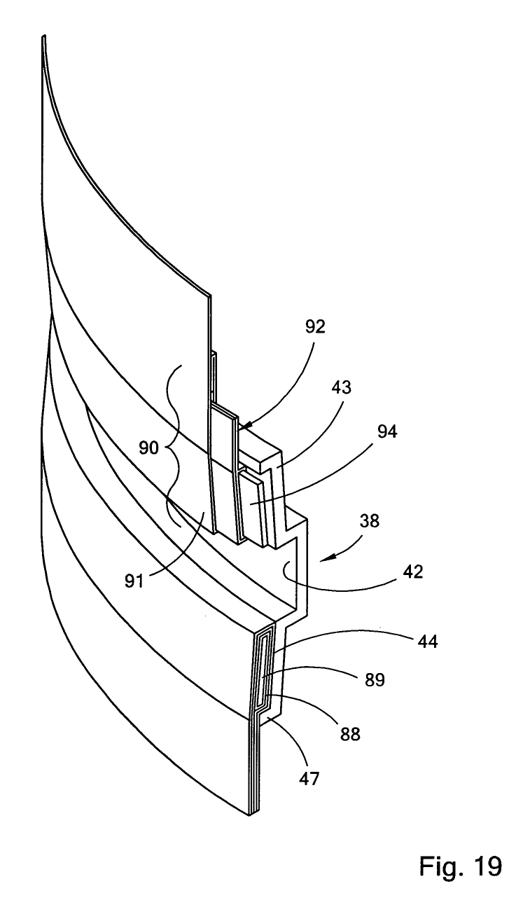

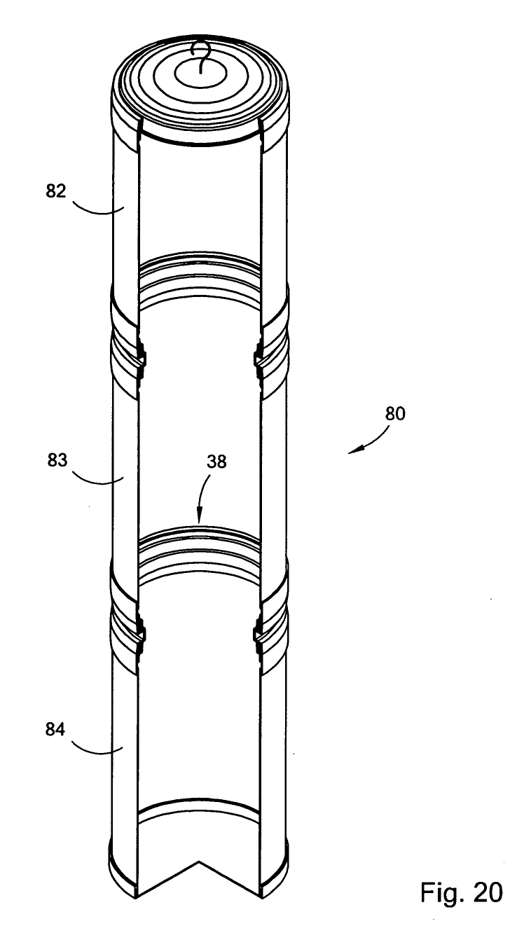

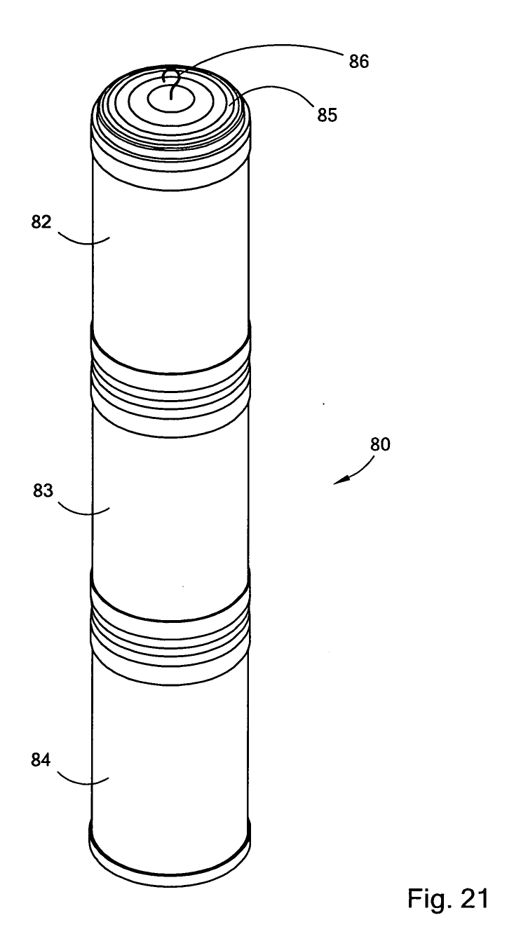

FIGS. 17-21 illustrate a new and improved OEM filter bag assembly, generally designated by the reference numeral 80. The improved filter 80 comprises a plurality of interconnected segments 82-84. A top 85 comprising hook 86 is attached to the top of segment 82. Splicing drums 38, designed as described previously, interconnect segments 82, 83, and 84.

The junction regions of the segments 82-84 that attach to the splicing drum preferably form a resilient compression band 88. The annular interior region 89 (FIG. 19) of the fabric compression bands may optionally be reinforced by a metallic band 88. In either case, the compression band (or metallic band) 88 is resiliently captivated upon the splicing drum 38 over lip 47 upon wedge 44 (FIG. 19).

FIG. 19 also reveals an alternative section termination 90. In this construction the end 91 of a segment is lapped over a separate double banded loop 92 that encircles a metallic snap band 94. This resilient snap band 94 is seated over wedge region 43 above annular central region 42. Optionally, especially for long, heavy lengths, an encircling hose clamp 50 may be added as aforedescribed.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings and claims is to be interpreted as illustrative and not in a limiting sense.

What is claimed is:

1. A kit for repairing damaged baghouse filters of the type comprising multiple, axially interconnected segments, the kit comprising:
at least one elongated, tubular replacement section adapted to be interconnected with the filter to replace each damaged segment, each replacement section comprising a pair of reinforced ends; and,
at least one annular splicing drum for interconnecting said at least one replacement section with at least one undamaged segment, the splicing drum adapted to be fitted to said reinforced ends;
wherein at least one of said replacement section reinforced ends is adapted to be fitted to said drum; and,
said undamaged segment fits over an opposite end of said drum.

2. The kit as defined in claim 1 wherein the splicing drum comprises:
a central, reduced diameter ring region defined at a drum midpoint;
a pair of integral, diverging wedge portions flared away from opposite sides of said ring region; and,
outer, coaxial, raised-diameter lips formed in the wedge portions;
wherein at least one of said replacement section reinforced ends is adapted to be fitted over one of said spool wedge portions; and,
said undamaged segment fits over an opposite splicing drum wedge portion.

3. A method for repairing damaged baghouse filters of the type comprising multiple serially aligned interconnected segments, the method comprising the steps of:
locating a damaged filter segment to be replaced;
cutting away the damaged segment to leave at least one undamaged segment;
providing an elongated, tubular replacement section adapted to be coupled to said undamaged segment, the replacement section comprising a pair of reinforced ends;
providing a splicing drum for interconnecting the replacement section with said undamaged segment, the splicing drum having a pair of ends adapted to receive snap bands, compression rings, or clamps;
fitting one of said replacement section reinforced ends over one of said drum ends; and,
fitting the undamaged segment over the opposite drum end.

4. The method as defined in claim 3 including the steps of providing said drum with a central, reduced diameter ring region defined at the drum midpoint, a pair of integral, diverging wedge portions flared away from opposite sides of said ring region, and outer, coaxial, raised-diameter lips in the wedge portions.

5. The method as defined in claim 4 including the steps of fitting one of said replacement section reinforced ends over one of said spool wedge portions and fitting the undamaged segment over the opposite splicing drum wedge portion.

6. The method as defined in claim 5 including the further step of providing the replacement section with at least one end comprising concentric, spaced apart ring portions adapted to be resiliently fitted to said drum.

7. An improved baghouse filter comprising:
multiple, axially interconnected segments, each segment comprising an elongated filter body section and a pair of spaced apart reinforced ends;
at least one annular splicing drum for interconnecting the segments, the splicing drum comprising a pair of ends adapted to be coaxially coupled to said segments;
wherein said segments have resilient ends adapted to be fitted to said drum ends.

8. The baghouse filter as defined in claim 7 wherein the splicing drum comprises:
a central, reduced diameter ring region defined at a drum midpoint;
a pair of integral, diverging wedge portions flared away from opposite sides of said ring region; and,
outer, coaxial, raised-diameter lips formed in the wedge portions.
wherein at least one of said replacement section reinforced ends is adapted to be fitted over one of said spool wedge portions; and,
said undamaged segment fits over an opposite splicing drum wedge portion.

9. The baghouse filter as defined in claim 8 wherein at least one of said segments has reinforced ends adapted to be fitted over one of said spool wedge portions.
